(19) United States
(12) Patent Application Publication
(10) Pub. No.: US 2015/0082137 A1
(43) Pub. Date: Mar. 19, 2015

(54) CREATING MEASURES FROM FORMULA ON OTHER MEASURES

(71) Applicant: Emmanuel Zarpas, Paris (FR)

(72) Inventor: Emmanuel Zarpas, Paris (FR)

(73) Assignee: Business Objects Software Ltd., Dublin (IE)

(21) Appl. No.: 14/028,740

(22) Filed: Sep. 17, 2013

(51) Int. Cl. G06F 17/21; G06F 3/0484; G06F 17/24

(52) U.S. Cl. CPC G06F 17/212; G06F 17/246; G06F 3/0484
USPC 715/212; 715/273

(57) ABSTRACT

Methods, systems, and computer-readable storage media for providing a calculated measure from one or more existing measures of a data object. Actions include receiving data associated with the data object, displaying a data visualization based on the data, the data visualization being displayed within a graphical user interface (GUI), receiving user input, the user input defining the calculated measure, the calculated measure being a function of at least one existing measure of the data object, at least one dimension of the data object, and an aggregation schema, and providing a modified data visualization for display, the modified data visualization including the calculated measure.

### BACKGROUND

Analyzing large datasets has become a common activity in many industrial fields. Generally, datasets are acquired from internal and/or external sources as quantitative data, which can be used in statistical analyses to support accurate and timely business decisions. Data visualization tools have been developed to provide graphical representations of underlying data, e.g., as tables, graphs. Data visualization tools, however, can be limited. For example, a data visualization tool might not enable users to accurately perform calculations based on the underlying data.

### SUMMARY

Implementations of the present disclosure include computer-implemented methods for providing a calculated measure from one or more existing measures of a data object. In some implementations, methods include actions of receiving data associated with the data object, displaying a data visualization based on the data, the data visualization being displayed within a graphical user interface (GUI), receiving user input, the user input defining the calculated measure, the calculated measure being a function of at least one existing measure of the data object, at least one dimension of the data object, and an aggregation schema, and providing a modified data visualization for display, the modified data visualization including the calculated measure.

In some implementations, the data object includes a data cube including the data, the data including one or more measures categorized into one or more dimensions, the one or more dimensions including the at least one dimension.

In some implementations, the data cube is a representation of a multi-dimensional spreadsheet associated with a multi-dimensional dataset including a plurality of data tables.

In some implementations, the aggregation schema maps measure data values of the at least one existing measure a respective measure column provided in the data visualization and the modified data visualization based on respective dimension values of the at least one dimension.

In some implementations, actions further include receiving user input indicating a change of the at least one dimension from a first dimension to a second dimension, in response to the user input, updating the calculated measure based on the second dimension to provide an updated calculated measure, and updating the data visualization based on the updated calculated measure.

In some implementations, the modified data visualization includes a fact table, the at least one existing measure corresponding to a first column of the fact table, the calculated measure corresponding to a second column of the fact table, and the at least one dimension corresponding to a third column of the fact table.

In some implementations, the calculated measure is a function of at least two existing measures.

In some implementations, actions further include providing a user interface (UI) for display, the user input defining the calculated measure being provided through the UI.

In some implementations, the UI is provided in response to user input indicating that the calculated measure is to be generated.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example system that can be used to execute implementations of the present disclosure.

FIG. 2 depicts a portion of an example graphical user interface for displaying data visualizations.

FIGS. 3A-3D depict creation of an example measure from example measures.

FIG. 4 depicts an example process that can be executed in accordance with implementations of the present disclosure.

FIG. 5 is a schematic illustration of example computer systems that can be used to execute implementations of the present disclosure.

Like reference symbols in the various drawings indicate like elements.

### DETAILED DESCRIPTION

Implementations of the present disclosure are generally directed to creating measures based on one or more measures. More specifically, implementations provide user interfaces (UIs) that enable a user to visually create a new measure based on one or more existing measures of a data object. In some implementations, the user can provide a command to calculate a new measure and, in response, a formula interface can be provided. In some examples, the formula interface enables the user to define a formula to calculate the new measure, referred to herein as a calculated measure, based on existing measures. In some examples, the formula includes at least one existing measure. In some examples, the formula includes at least two existing measures. In some implementations, the calculated measure is provided based on the formula and an aggregation schema. In some examples, the aggregation schema is associated with a fact table that is to include the calculated measure.

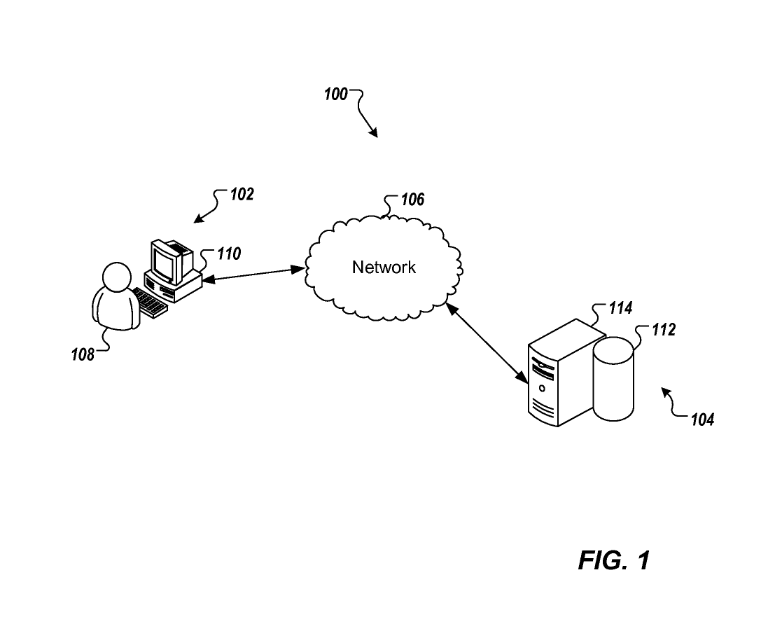

FIG. 1 depicts an example system 100 that can be used to execute implementations of the present disclosure. The example system 100 includes a user workstation 102, a server system 104 and a network 106. In the depicted example, a user 108 interacts with the user workstation 102. In an example context, the user 108 can include a data analyst of a company or a department of a company (e.g., warehouse).

In the depicted example, the user workstation 102 includes a computing device 110. In some examples, the computing device 110 can communicate with the server system 104 over the network 106. In some examples, the computing device 110 can include any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices.

In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes a server 112 and a data store 114. In the example of FIG. 1, the server system 104 is intended to represent various forms of servers including, but not limited to a web server, an application server, a proxy server, a network server, and/or a server pool. In general, the server system 104 accepts user requests for application services and provides such services to any number of client devices (e.g., the computing device 110) over the network 106. In some implementations, the server system 104 can provide a central point through which service-providers can manage and access data related to web services.

In some examples, data visualizations, e.g., tables, graphs, histograms, can be generated and can be displayed to the user 108 on the computing device 110. In some examples, data is stored in the server system 104 is accessed for generation of a data visualization. In some examples, the computing device 110 executes data visualization software that retrieves data from the server system 104 and generates the data visualization. In some examples, the server system 104 executes data visualization software that retrieves data from the server system 104 and generates instructions that are provided to the computing device 110 to display the data visualization (e.g., the data visualization software is server-based and the computing device 110 functions as a client computing device).

In some implementations, software can be stored in memory of each of the computing devices to provide instructions to a processor (not shown) to perform various functions in accordance with implementations of the present disclosure. For example, the computing device 110 can store and execute software, such as an operating system and/or application programs. Implementations of the present disclosure can also include computer executable instructions, such as program modules executable by a computing device. In some examples, program modules can be defined as routines, programs, objects, components and/or data structures that perform particular tasks and/or that implement particular abstract data types.

Continuing, data visualization tools (data visualization software) can be provided to generate and display data visualizations. An example data visualization tool is SAP Lumira provided by SAP AG of Walldorf, Germany. In some examples, the visualized data can include internally and/or externally retrieved data. In some examples, the data, that is to be visualized on the device 110, can be retrieved over the network 106 from the server system 104 or from external databases. In some examples, data is automatically retrieved (e.g. at particular intervals) or randomly retrieved from one or more external sources and stored in data store 114. In some examples, the user 108 generates instructions to retrieve the data for visualization and analysis. In some examples, a user can include a private person, a service agency or a company.

In general, implementations of the present disclosure enable measures to be calculated based on existing measures. More particularly, implementations of the present disclosure enable measures to be calculated based on existing measures of data objects. An example data object can be provided as a data cube, e.g., an online analytical processing (OLAP) data cube. In some examples, a data cube is provided as an array of data categorized into one or more dimensions. For example, and as discussed in further detail herein, a data cube can be a representation of a multi-dimensional spreadsheet, e.g., a multi-dimensional dataset including a plurality of data tables. In some examples, a data cube includes a plurality of cells, where cells are populated with respective values, e.g., number, text. In some examples, each value represents some measure, e.g., of a business, such as sales, revenue, profits, expenses, budget and forecast.

Implementations of the present disclosure will be discussed in further detail herein with reference to an example context. The example context includes business data, e.g., data reflecting operations of an enterprise. In this example context, an example data object can include a business object (BO) that includes data related to operations of an enterprise. It is appreciated, however, that implementations of the present disclosure are applicable in other contexts.

In some implementations, and in the example context, a data cube represents a data object defining a predefined or pre-calculated view on business data. Accordingly, the data cube can be referred to as a calculated view. As explained more fully below, the business data may be presented to the user in any of a variety of techniques and views, such as, for example, reports, tables, notes, graphs, and other views. The business data may be connected and/or related according to any of a variety of contexts, such as, for example, a particular business issue or problem, a particular product or service, a particular organizational unit and/or portion of a business enterprise, across a particular position and/or user role found within the business enterprise, and other contexts.

In accordance with implementations of the present disclosure, a data cube can enable manipulation and/or analysis of data stored in the data cube from multiple perspectives, e.g., by dimensions, measures, and/or elements of the data cube. In some examples, a dimension of a data cube defines a category of stored data. Example dimensions can include time, location, product. In some examples, each dimension can have one or more sub-dimensions. For example, the time dimension can include sub-dimensions of year, each sub-dimension of year can include sub-dimensions of quarter, each sub-dimension of quarter can include sub-dimensions of month, each sub-dimension of month can include sub-dimensions of week, and so on. As another example, the product dimension can include sub-dimensions of category, and each sub-dimension of category can include sub-dimensions of line. As another example, the location dimension can include sub-dimensions of country, each sub-dimension of country can include sub-dimensions of region, e.g., north, east, west, south, mid-west, each sub-dimension of region can include sub-dimensions of sub-region, e.g., state, province, and each sub-dimension of sub-region can include sub-dimensions of city. In some examples, a data cube can include three-dimensions. In some examples, a data cube having more than three-dimensions is referred to as a hypercube.

As noted above, data stored in the data object includes one or more measures. In some examples, each measure is a fact, e.g., a numerical fact, a textual fact. In some examples, each measure can be categorized into one or more dimensions. Example measures can include specific product sales data, e.g., quantity sold, revenue, and/or profit margin, categorized by dimension. In short, measures can include any appropriate business data that may be manipulated according to business logic to assist or support the business enterprise.

In accordance with implementations of the present disclosure, new measures (also referred to as calculated measures) can be generated for a data object based on existing measures of the data object. More particularly, implementations of the present disclosure provide UIs that enable a user to define a calculated measure based on one or more existing measures. In some implementations, the user can provide a command to define a calculated measure and, in response, a formula interface can be provided. In some examples, the formula interface enables the user to define a formula to calculate the calculated measure based on existing measures. In some examples, the formula includes at least one existing measure. In some examples, the formula includes at least two existing measures. In some examples, the calculated measure is provided based on the following example relationship:

m_{CALC}=f(m₁,m₂) with respect to d

where m₁ and m₂ are included in a set of existing measures, e.g., m₁, . . . , mₙ, and d is a dimension.

In some examples, the calculated measure can be added to the dataset of the data object. In this manner, the calculated measure can be used to provide subsequent calculated measures. For example, a calculated measure m₃ can be determined based on existing measures m₁ and m₂. Another calculated measure m₄ can be determined based on the calculated measure m₃, which can also now be considered an existing measure.

In some implementations, the calculated measure is provided based on the formula and an aggregation schema. In some examples, the aggregation schema is associated with a fact table that is to include the calculated measure. In some examples, a fact table can include two or more columns, at least one column being associated with a respective measure, and at least one column being associated with a respective dimension. In some examples, the aggregation schema maps data values from measure tables to the measure columns included in the fact table based on respective dimension values from dimension tables. For example, if a dimension d and a measure m are included in the fact table, the aggregation schema maps dimension values to be included in the dimension column from a respective dimension table, and maps measure values in view of the dimension d to be included in the measure column from a respective measure table. An example aggregation schema is provided below.

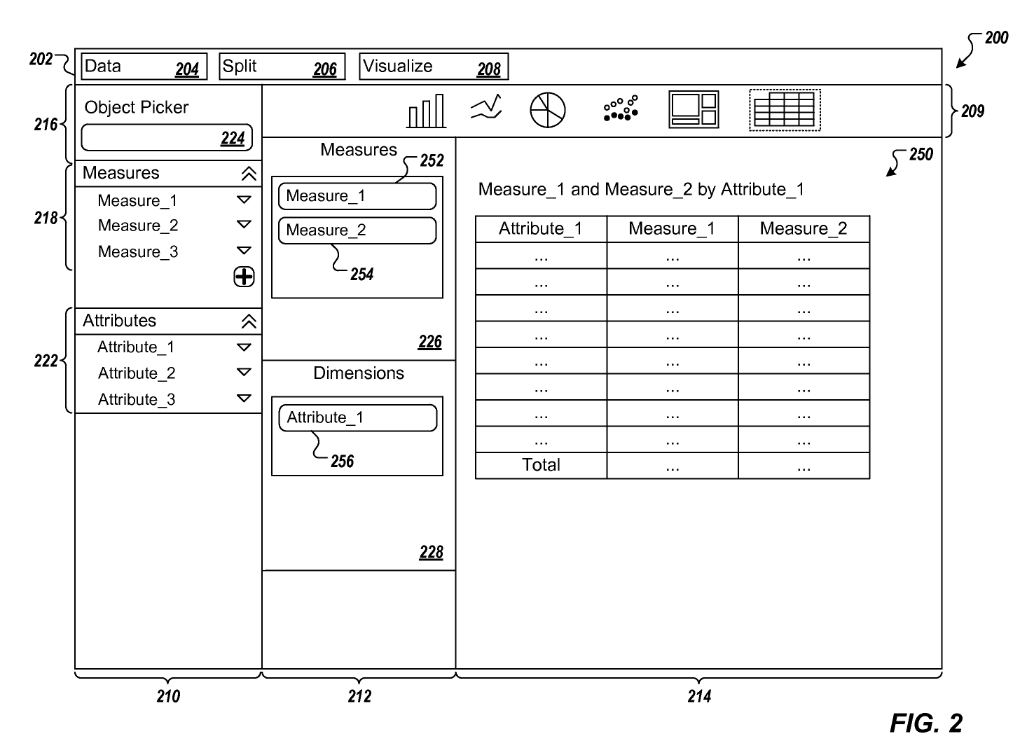

FIG. 2 depicts a portion of an example graphical user interface (GUI) 200 for displaying data visualizations. In some implementations, the GUI 200 can be the interface displayed by the computing device 110, with which the user 108 is interacting, as described with reference to FIG. 1.

In the example of FIG. 2, the GUI 200 includes a number of choices presented in a menu bar 202, such as data 204, split 206 and visualize 208, a visualization menu 209, an operations menu 210, a graphical menu 212 and a display section 214. In the present example, the choice visualize 208 has been selected by a user, and a fact table visualization has been selected from the visualization menu 209. Consequently, a fact table 250 is displayed in the display section 214. In some examples, selection of the choice data 204 causes the visualization application to connect to the database over the network to enable a user to see and to select a dataset from existent datasets stored in the database.

The operations menu 210 includes an object picker 216, a measures menu 218, and an attributes menu 222, associated with the currently displayed data. In some examples, the object picker 216 includes a search box 224 that enables searching of data objects that can be used in data visualizations. In some examples, the measures menu 218 lists measures of the data object that are available for data visualization.

In some examples, the selection of a measure indicates its use as a column of the fact table 250, as discussed in further detail herein. For example, the measure is selected by clicking on and dragging the measure to a measures box 226 of the graphical menu 212. In some implementations, multiple measures are chosen and can be displayed with differential markers (e.g., each measure could be defined by a particular color) in the display section 214. In the depicted example, respective icons 252, 254 are displayed in the measure box 226.

In some examples, the selection of an attribute indicates its use as a column of the fact table 250, as discussed in further detail herein. For example, the attribute is selected by clicking on and dragging the attribute to an attribute box 226 of the graphical menu 212. In some implementations, multiple attributes are chosen and can be displayed with differential markers (e.g., each measure could be defined by a particular color) in the display section 214. In the depicted example, an attribute icon 256 is displayed in the attribute box 228.

In the example of FIG. 2, the display section 214 includes the data visualization, such as the fact table 250 that is generated based on the underlying data. In some examples, the underlying data includes selected measures and dimensions, e.g., Measure_{—}1, Measure_{—}2, Attribute_{—}1. In some examples, the fact table 250 is provided based on an aggregation schema. More particularly, the aggregation schema defines the measure columns included in the fact table, and maps columns of dimension tables to dimension columns of the fact table. An example aggregation schema is provided below. In some examples, the aggregation schema is provided based on the measure(s) and dimension(s) selected by the user, and is used to retrieve data from respective tables, e.g., measure tables, dimension tables, to populate the fact table.

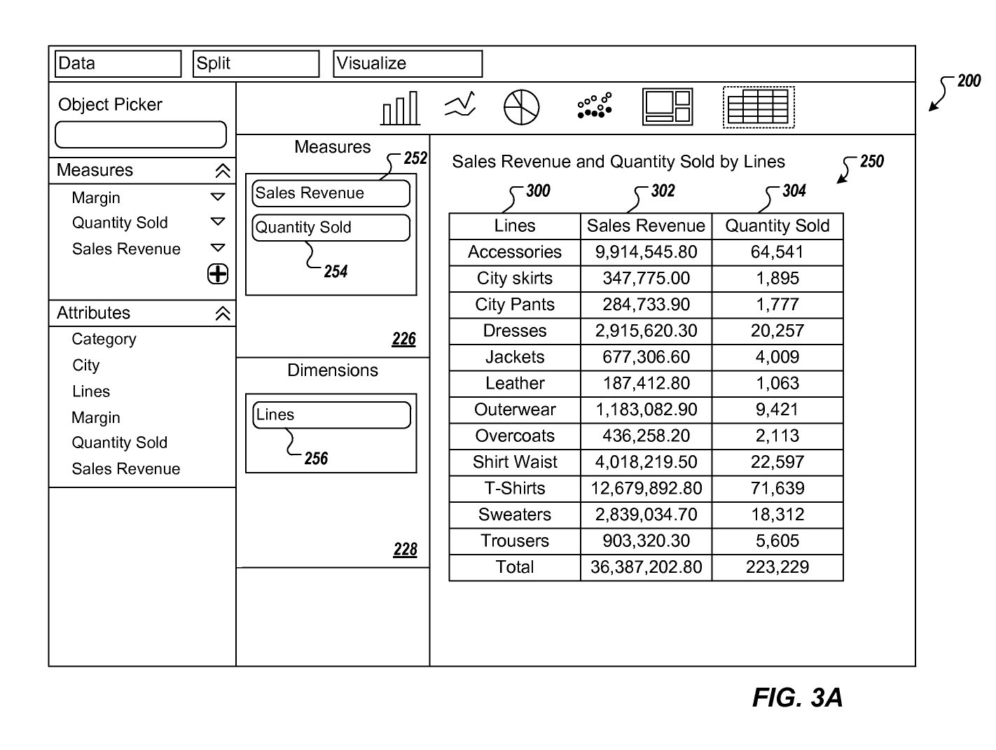

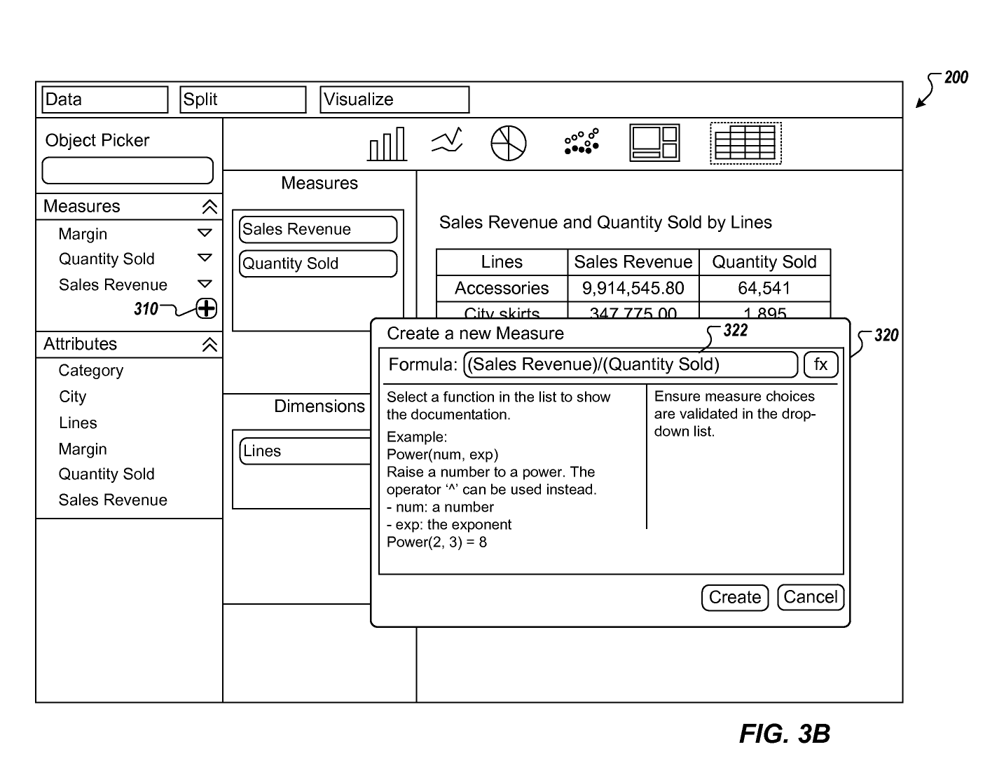

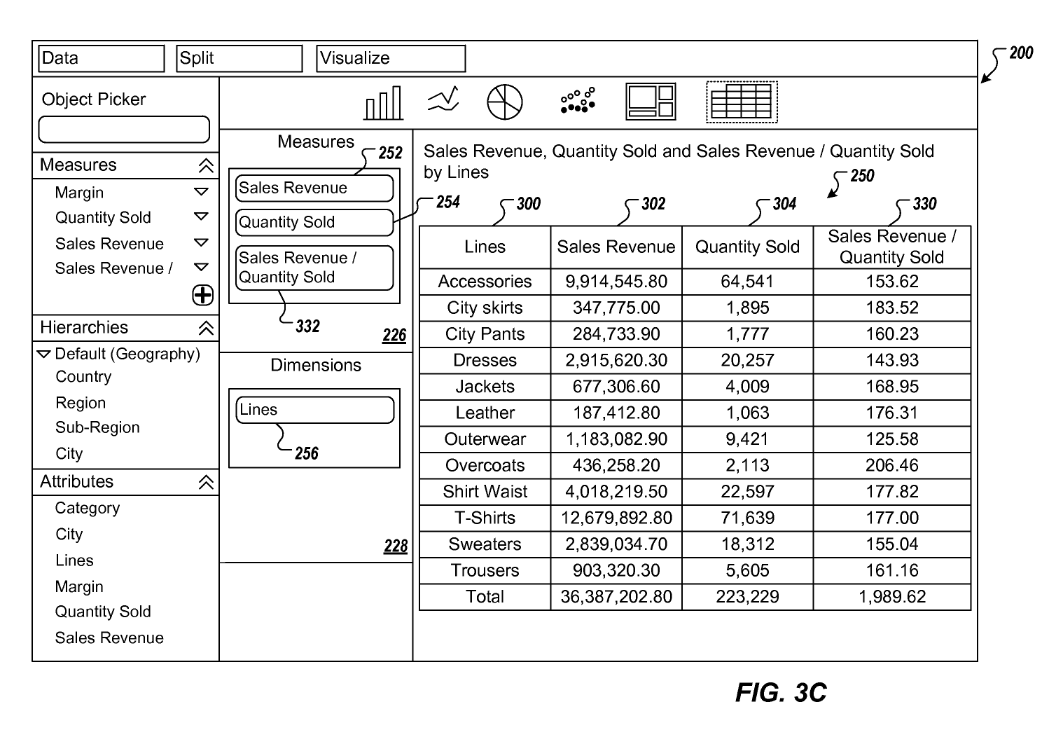

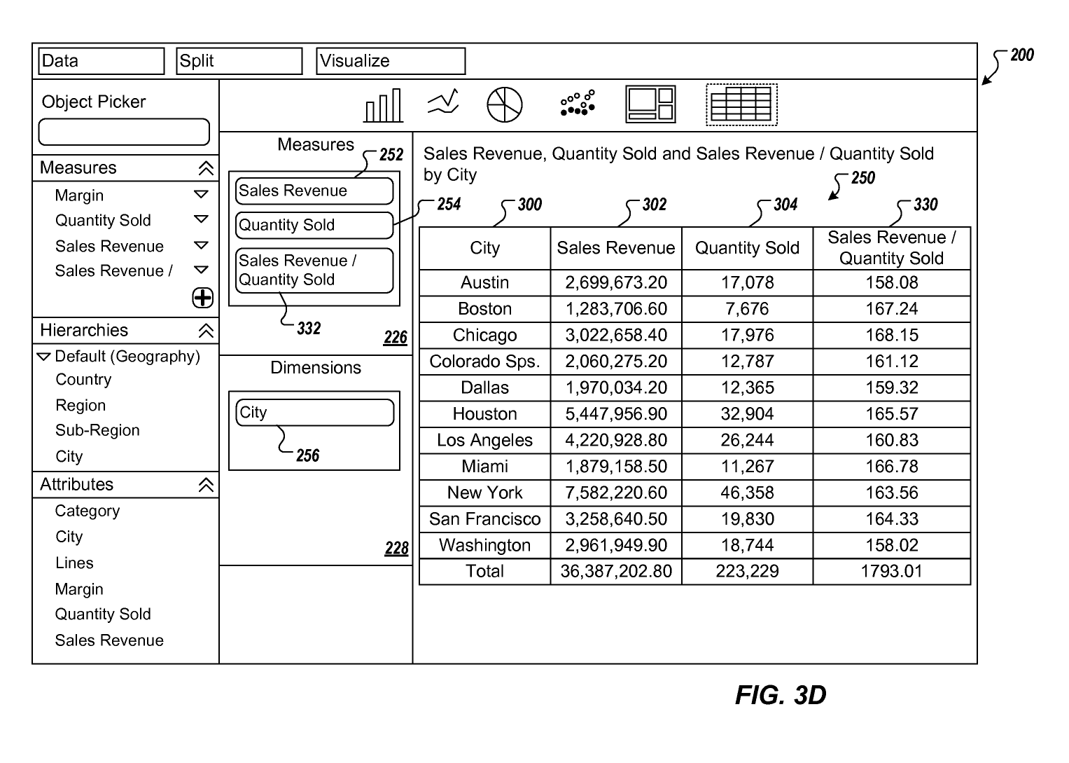

Referring now to FIGS. 3A-3D implementations of the present disclosure will be discussed in further detail by way of example. With particular reference to FIG. 3A, a fact table 250 is displayed and include columns 300, 302, 304. The column 300 corresponds to the selected dimension Lines, the column 302 corresponds to the selected measure Sales Revenue, and the column 304 corresponds to the selected measure Quantity Sold. Consequently, and in this example, the fact table 250 depicts the measure Sales Revenue and the measure Quantity Sold of products by the dimension Lines. Accordingly, an aggregation schema of the fact table 250 can map dimension values, e.g., Accessories, City Skirts, City Pants, etc., from a Lines dimension table to the column 300, and can map measure values for both Sales Revenue and Quantity Sold from respective measure tables based on the dimension Lines.

As introduced above, implementations of the present disclosure enable users to define calculated measures based on existing measures. With particular reference to FIG. 3B, a user can indicate a command to define a calculated measure. In some examples, the command can be indicated in response to user interaction with the GUI 200. In the depicted example, the user can select, e.g., click on, an icon 310 to indicate that a calculated measure is to be defined. In some examples, in response to user selection of the icon 310, a measure definition interface 320 is displayed. The measure definition interface 320 includes a text box 322, into which the user can input text to define a formula for the calculated measure. In some examples, the formula includes at least one measure. In the depicted example, the formula is provided as the ratio between the measure Sales Revenue and the measure Quantity. In this manner, the formula defines the calculated measure, e.g., as Average Revenue.

Referring now to FIG. 3C, the fact table 250 has been updated to include a column 330 corresponding to the calculated measure, and a corresponding measure icon 332 is included in the measures box. The values of the calculated measure that are provided in the column 330 are determined based on the measures Sales Revenue and Quantity Sold in view of the dimension Lines. For example, for Accessories, a Sales Revenue value, e.g., 9,914,545.80, corresponding to Accessories is mapped from a Sales Revenue measure table, a Quantity Sold value, e.g., 64,541, corresponding to Accessories is mapped from a Quantity Sold measure table. The retrieved measures are provided as input to the formula to provide the Calculated Measure value, e.g., 153.62, corresponding to Accessories.

Referring now to FIG. 3D, the user can select another dimension to view the measures and the calculated measure with respect to. In the example of FIG. 3D, the user has selected the dimension City in place of the dimension Lines, and the fact table 250 can be automatically updated to display appropriate measure values and calculated measure values. For example, for Austin, a Sales Revenue value, e.g., 2,699,673.20, corresponding to Austin is mapped from a Sales Revenue measure table, a Quantity Sold value, e.g., 17,078, corresponding to Austin is mapped from a Quantity Sold measure table. The retrieved measures are provided as input to the formula to provide the Calculated Measure value, e.g., 158.08, corresponding to Austin.

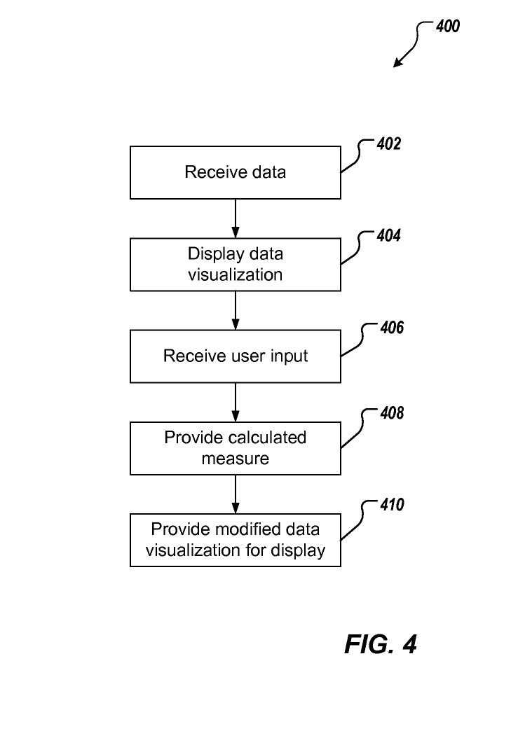

FIG. 4 depicts an example process 400 that can be executed in accordance with implementations of the present disclosure. In some examples, the example process 400 can be provided using one or more computer-executable programs executed using one or more computing devices, e.g., the server system 104 of FIG. 1. The example process 400 can be used for providing a calculated measure from one or more existing measures of a data object.

Data is received by one or more processors (402). In some implementations, data is received in response to a user request. A data visualization is displayed based on the data (404). For example, the data visualization is displayed within a GUI (as illustrated in FIG. 2). In some examples, the data visualization is displayed as a fact table including a plurality of columns. In some examples, a column corresponds to a dimension of the data object and a column corresponds to an existing measure of the data object.

User input is received (406). In some examples, the user input defines a calculated measure, the calculated measure being a function of at least one existing measure of the data object, at least one dimension of the data object, and an aggregation schema. A modified data visualization is provided for display (410). In some examples, the modified data visualization is provided as an updated fact table that includes the column corresponding to the dimension, the column corresponding to the existing measure, and a column that correspond to the calculated measure.

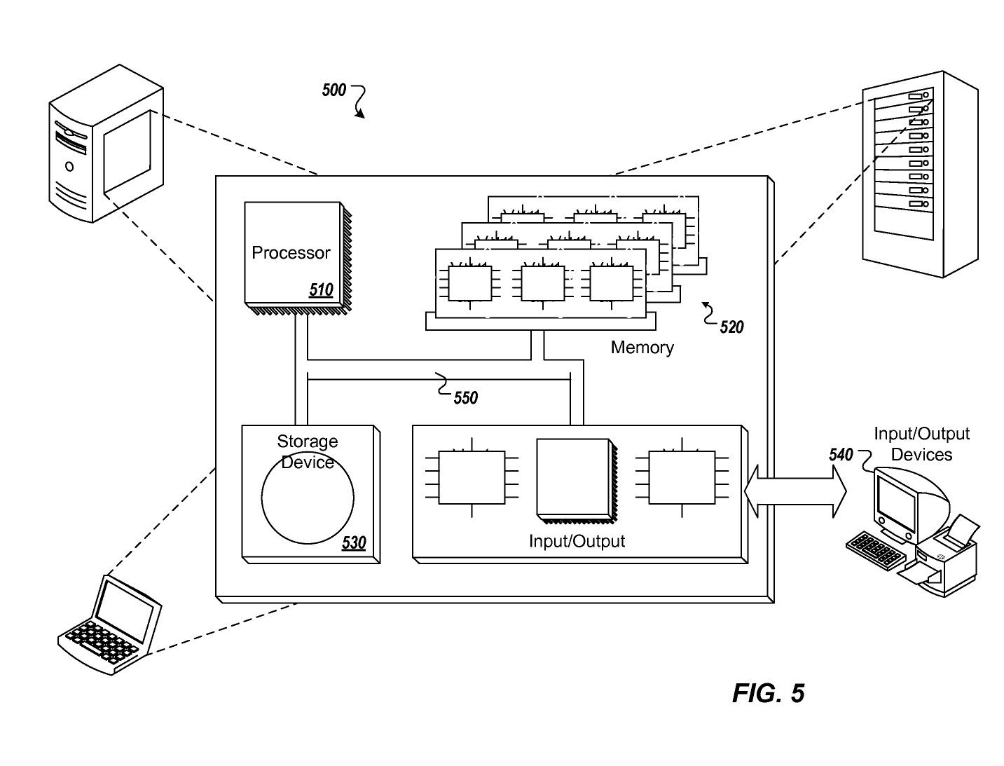

Referring now to FIG. 5, a schematic diagram of an example computing system 500 is provided. The system 500 can be used for the operations described in association with the implementations described herein. For example, the system 500 may be included in any or all of the server components discussed herein. The system 500 includes a processor 510, a memory 520, a storage device 530, and an input/output device 540. Each of the components 510, 520, 530, and 540 are interconnected using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the system 500. In one implementation, the memory 520 is a computer-readable medium. In one implementation, the memory 520 is a volatile memory unit. In another implementation, the memory 520 is a non-volatile memory unit. The storage device 530 is capable of providing mass storage for the system 500. In one implementation, the storage device 530 is a computer-readable medium. In various different implementations, the storage device 530 may be a floppy disk device, a hard disk device, an optical disk device, or a tape device. The input/output device 540 provides input/output operations for the system 500. In one implementation, the input/output device 540 includes a keyboard and/or pointing device. In another implementation, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for providing a calculated measure from one or more existing measures of a data object, the method being executed using one or more processors and comprising:
receiving, by the one or more processors, data associated with the data object;
displaying, by the one or more processors, a data visualization based on the data, the data visualization being displayed within a graphical user interface (GUI);
receiving, by the one or more processors, user input, the user input defining the calculated measure, the calculated measure being a function of at least one existing measure of the data object, at least one dimension of the data object, and an aggregation schema; and
providing a modified data visualization for display, the modified data visualization comprising the calculated measure.

2. The method of claim 1, wherein the data object comprises a data cube comprising the data, the data comprising one or more measures categorized into one or more dimensions, the one or more dimensions comprising the at least one dimension.

3. The method of claim 2, wherein the data cube is a representation of a multi-dimensional spreadsheet associated with a multi-dimensional dataset including a plurality of data tables.

4. The method of claim 1, wherein the aggregation schema maps measure data values of the at least one existing measure a respective measure column provided in the data visualization and the modified data visualization based on respective dimension values of the at least one dimension.

5. The method of claim 1, further comprising:
receiving user input indicating a change of the at least one dimension from a first dimension to a second dimension;
in response to the user input, updating the calculated measure based on the second dimension to provide an updated calculated measure; and
updating the data visualization based on the updated calculated measure.

6. The method of claim 1, wherein the modified data visualization comprises a fact table, the at least one existing measure corresponding to a first column of the fact table, the calculated measure corresponding to a second column of the fact table, and the at least one dimension corresponding to a third column of the fact table.

7. The method of claim 1, wherein the calculated measure is a function of at least two existing measures.

8. The method of claim 1, further comprising providing a user interface (UI) for display, the user input defining the calculated measure being provided through the UI.

9. The method of claim 8, wherein the UI is provided in response to user input indicating that the calculated measure is to be generated.

10. A non-transitory computer-readable storage medium coupled to one or more processors and having instructions stored thereon which, when executed by the one or more processors, cause the one or more processors to perform operations for providing a calculated measure from one or more existing measures of a data object, the operations comprising:
receiving data associated with the data object;
displaying a data visualization based on the data, the data visualization being displayed within a graphical user interface (GUI);
receiving user input, the user input defining the calculated measure, the calculated measure being a function of at least one existing measure of the data object, at least one dimension of the data object, and an aggregation schema; and
providing a modified data visualization for display, the modified data visualization comprising the calculated measure.

11. The computer-readable storage medium of claim 10, wherein the data object comprises a data cube comprising the data, the data comprising one or more measures categorized into one or more dimensions, the one or more dimensions comprising the at least one dimension.

12. The computer-readable storage medium of claim 11, wherein the data cube is a representation of a multi-dimensional spreadsheet associated with a multi-dimensional dataset including a plurality of data tables.

13. The computer-readable storage medium of claim 10, wherein the aggregation schema maps measure data values of the at least one existing measure a respective measure column provided in the data visualization and the modified data visualization based on respective dimension values of the at least one dimension.

14. The computer-readable storage medium of claim 10, wherein operations further comprise:
receiving user input indicating a change of the at least one dimension from a first dimension to a second dimension;
in response to the user input, updating the calculated measure based on the second dimension to provide an updated calculated measure; and
updating the data visualization based on the updated calculated measure.

15. A system, comprising:
a computing device; and
a computer-readable storage device coupled to the computing device and having instructions stored thereon which, when executed by the computing device, cause the computing device to perform operations for providing a calculated measure from one or more existing measures of a data object, the operations comprising:
receiving data associated with the data object;
displaying a data visualization based on the data, the data visualization being displayed within a graphical user interface (GUI);
receiving user input, the user input defining the calculated measure, the calculated measure being a function of at least one existing measure of the data object, at least one dimension of the data object, and an aggregation schema; and
providing a modified data visualization for display, the modified data visualization comprising the calculated measure.

16. The system of claim 15, wherein the data object comprises a data cube comprising the data, the data comprising one or more measures categorized into one or more dimensions, the one or more dimensions comprising the at least one dimension.

17. The system of claim 16, wherein the data cube is a representation of a multi-dimensional spreadsheet associated with a multi-dimensional dataset including a plurality of data tables.

18. The system of claim 15, wherein the aggregation schema maps measure data values of the at least one existing measure a respective measure column provided in the data visualization and the modified data visualization based on respective dimension values of the at least one dimension.

19. The system of claim 15, wherein operations further comprise:
receiving user input indicating a change of the at least one dimension from a first dimension to a second dimension;
in response to the user input, updating the calculated measure based on the second dimension to provide an updated calculated measure; and
updating the data visualization based on the updated calculated measure.
